(19) United States
(12) Patent Application Publication
(10) Pub. No.: US 2017/0223797 A1
(43) Pub. Date: Aug. 3, 2017

(54) TOUCH-BASED LIGHTING CONTROL USING THERMAL IMAGING

(71) Applicant: PHILIPS LIGHTING HOLDING B.V., Eindhoven (NL)

(72) Inventors: RUBEN RAJAGOPALAN, NEUSS (DE); HARRY BROERS, 'S-HERTOGENBOSCH (NL)

(21) Appl. No.: 15/408,915

(22) Filed: Jan. 18, 2017

Related U.S. Application Data
(60) Provisional application No. 62/288,503, filed on Jan. 29, 2016.

(30) Foreign Application Priority Data
Mar. 31, 2016 (EP) 16163118.9

(51) Int. Cl. H05B 33/08; H04N 5/33; G06F 3/042

(52) U.S. Cl. CPC H05B 33/0854; G06F 3/0425; H04N 5/33

(57) ABSTRACT

In various embodiments, a lighting control apparatus (100) may include logic such as a controller (102, 202, 302, 502) and a thermal imaging sensor (108, 208, 308, 408a-b, 508) operably coupled with the controller. The thermal imaging sensor may have at least one field of view (110, 210, 310, 410a-b, 510) pointed at a surface (112, 212, 312, 412a-b, 512, 612). The surface may exhibit various degrees of thermal conductivity. The controller may be configured to: receive a signal from the thermal imaging sensor, the signal being indicative of heat (114) captured by the surface and sensed by the thermal imaging sensor. Based on the signal received from the thermal imaging sensor, the controller may cause one or more light sources (104, 204, 304, 504) to emit light having one or more selected properties.

### TECHNICAL FIELD

The present invention is directed generally to lighting control. More particularly, various inventive methods and apparatus disclosed herein relate to touch-based lighting control using thermal imaging.

### BACKGROUND

Various techniques exist for controlling light output human using touch. Resistive touch interfaces detect when human touch has created contact between resistive circuit layers to close a switch. In capacitive touch interfaces, voltage is applied to a surface, small changes in current to the surface caused by human touch are detected, and the locations of those touches are calculated by a controller. In surface acoustic interfaces, acoustic waves are applied in one or more directions across a surface, and then interruptions to those acoustic waves caused by human touch are detected. In optical (or infrared) interfaces, human touch to a surface causes one or more detectable interruptions to one or more light beams cast across the surface. Incorporating these technologies into lighting units, lighting fixtures, and/or luminaires to facilitate lighting control may be economically infeasible and/or technically cumbersome. Thus, there is a need in the art to provide touch-based lighting control in a more economical and technically feasible manner.

### SUMMARY

The present disclosure is directed to inventive methods and apparatus for touch-based lighting control using thermal imaging. For example, a lighting control system may include a thermal imaging sensor with a field of view (“FoV”) pointed at a particular surface. The thermal imaging sensor may be configured to sense heat at least temporarily captured in the thermally-conductive surface and provide a signal indicative thereof to a controller. The controller may be configured to operate one or more light sources based on the signal. For example, a user may perform various touch-gestures on the thermally conductive surface, such as a swipe, a tap, and so forth, to cause the controller to operate the one or more light sources to emit light in a particular manner, e.g., having a particular hue, intensity, color temperature, dynamic pattern, etc.

Generally, in one aspect, a lighting control apparatus may include a controller and a thermal imaging sensor operably coupled with the controller. The thermal imaging sensor may have at least one field of view pointed at a surface. The controller may be configured to: receive a signal from the thermal imaging sensor, the signal being indicative of heat captured by the surface and sensed by the thermal imaging sensor; and cause one or more light sources to emit light in a manner selected based at least in part on the signal. In various versions, the surface may be thermally conductive.

In various embodiments, a lighting unit may include the aforementioned lighting control apparatus, e.g., along with the one or more light sources and an envelope to enclose the one or more light sources. The envelope may include the thermally-conductive surface. In various embodiments, the surface may be independent from the lighting control apparatus. For example, the surface may include a wall, ceiling, or floor of a room in which the lighting control apparatus is installed.

In various embodiments, a lighting fixture may include the aforementioned lighting control apparatus, as well as a body with a socket adapted to receive a lighting unit. In some versions, the lighting fixture may further include a lampshade mounted on the body, and the lampshade may include the thermally-conductive surface. In some versions, a lighting unit installed in the socket may be communicatively coupled to the lighting control apparatus. In some versions, the lighting control apparatus may be secured to a housing of the lighting fixture.

In various embodiments, the controller may be configured to cause the one or more light sources to emit light having one or more properties selected based on a shape of the heat captured by the surface or a location of the heat captured by the surface within the at least one field of view. In various embodiments, the thermal imaging sensor may include a first thermal imaging sensor with a first field of view pointed at a first surface, and the lighting control apparatus may further include a second thermal imaging sensor having a second field of view pointed at a second surface. In some such embodiments, the controller may be configured to: cause the one or more light sources to emit light having a first property in response to a signal from the first thermal imaging sensor indicative of heat captured by the first surface; and cause the one or more light sources to emit light having a second property in response to a signal from the second thermal imaging sensor indicative of heat captured by the second surface. In various versions, the first property may be task lighting and the second property may be general lighting.

In some embodiments, a mobile computing device may include one or more of the aforementioned lighting control apparatus, as well as memory storing instructions configured to cause the controller to implement a lighting control software application. In various embodiments, the lighting control application may cause the one or more light sources to emit light having one or more properties selected based on the signal provided by the thermal imaging sensor.

As used herein for purposes of the present disclosure, the term “LED” should be understood to include any electroluminescent diode or other type of carrier injection/junction-based system that is capable of generating radiation in response to an electric signal. Thus, the term LED includes, but is not limited to, various semiconductor-based structures that emit light in response to current, light emitting polymers, organic light emitting diodes (OLEDs), electroluminescent strips, and the like. In particular, the term LED refers to light emitting diodes of all types (including semi-conductor and organic light emitting diodes) that may be configured to generate radiation in one or more of the infrared spectrum, ultraviolet spectrum, and various portions of the visible spectrum (generally including radiation wavelengths from approximately 400 nanometers to approximately 700 nanometers). Some examples of LEDs include, but are not limited to, various types of infrared LEDs, ultraviolet LEDs, red LEDs, blue LEDs, green LEDs, yellow LEDs, amber LEDs, orange LEDs, and white LEDs (discussed further below). It also should be appreciated that LEDs may be configured and/or controlled to generate radiation having various bandwidths (e.g., full widths at half maximum, or FWHM) for a given spectrum (e.g., narrow bandwidth, broad bandwidth), and a variety of dominant wavelengths within a given general color categorization.

The term “light source” should be understood to refer to any one or more of a variety of radiation sources, including, but not limited to, LED-based sources (including one or more LEDs as defined above), incandescent sources (e.g., filament lamps, halogen lamps), fluorescent sources, phosphorescent sources, high-intensity discharge sources (e.g., sodium vapor, mercury vapor, and metal halide lamps), lasers, other types of electroluminescent sources, pyro-luminescent sources (e.g., flames), candle-luminescent sources (e.g., gas mantles, carbon arc radiation sources), photo-luminescent sources (e.g., gaseous discharge sources), cathode luminescent sources using electronic satiation, galvano-luminescent sources, crystallo-luminescent sources, kine-luminescent sources, thermo-luminescent sources, triboluminescent sources, sonoluminescent sources, radioluminescent sources, and luminescent polymers.

A given light source may be configured to generate electromagnetic radiation within the visible spectrum, outside the visible spectrum, or a combination of both. Hence, the terms “light” and “radiation” are used interchangeably herein. Additionally, a light source may include as an integral component one or more filters (e.g., color filters), lenses, or other optical components. Also, it should be understood that light sources may be configured for a variety of applications, including, but not limited to, indication, display, and/or illumination. An “illumination source” is a light source that is particularly configured to generate radiation having a sufficient intensity to effectively illuminate an interior or exterior space. In this context, “sufficient intensity” refers to sufficient radiant power in the visible spectrum generated in the space or environment (the unit “lumens” often is employed to represent the total light output from a light source in all directions, in terms of radiant power or “luminous flux”) to provide ambient illumination (i.e., light that may be perceived indirectly and that may be, for example, reflected off of one or more of a variety of intervening surfaces before being perceived in whole or in part).

The term “lighting fixture” is used herein to refer to an implementation or arrangement of one or more lighting units in a particular form factor, assembly, or package. The term “lighting unit” is used herein to refer to an apparatus including one or more light sources of same or different types. A given lighting unit may have any one of a variety of mounting arrangements for the light source(s), enclosure/housing arrangements and shapes, and/or electrical and mechanical connection configurations. Additionally, a given lighting unit optionally may be associated with (e.g., include, be coupled to and/or packaged together with) various other components (e.g., control circuitry) relating to the operation of the light source(s). An “LED-based lighting unit” refers to a lighting unit that includes one or more LED-based light sources as discussed above, alone or in combination with other non LED-based light sources. A “multi-channel” lighting unit refers to an LED-based or non LED-based lighting unit that includes at least two light sources configured to respectively generate different spectrums of radiation, wherein each different source spectrum may be referred to as a “channel” of the multi-channel lighting unit.

The term “controller” is used herein generally to describe various apparatus relating to the operation of one or more light sources. A controller can be implemented in numerous ways (e.g., such as with dedicated hardware) to perform various functions discussed herein. A “processor” is one example of a controller which employs one or more microprocessors that may be programmed using software (e.g., microcode) to perform various functions discussed herein. A controller may be implemented with or without employing a processor, and also may be implemented as a combination of dedicated hardware to perform some functions and a processor (e.g., one or more programmed microprocessors and associated circuitry) to perform other functions. Examples of controller components that may be employed in various embodiments of the present disclosure include, but are not limited to, conventional microprocessors, application specific integrated circuits (ASICs), and field-programmable gate arrays (FPGAs).

In various implementations, a processor or controller may be associated with one or more storage media (generically referred to herein as “memory,” e.g., volatile and non-volatile computer memory such as RAM, PROM, EPROM, and EEPROM, floppy disks, compact disks, optical disks, magnetic tape, etc.). In some implementations, the storage media may be encoded with one or more programs that, when executed on one or more processors and/or controllers, perform at least some of the functions discussed herein. Various storage media may be fixed within a processor or controller or may be transportable, such that the one or more programs stored thereon can be loaded into a processor or controller so as to implement various aspects of the present invention discussed herein. The terms “program” or “computer program” are used herein in a generic sense to refer to any type of computer code (e.g., software or microcode) that can be employed to program one or more processors or controllers.

The term “user interface” as used herein refers to an interface between a human user or operator and one or more devices that enables communication between the user and the device(s). Examples of user interfaces that may be employed in various implementations of the present disclosure include, but are not limited to, switches, potentiometers, buttons, dials, sliders, a mouse, keyboard, keypad, various types of game controllers (e.g., joysticks), track balls, display screens, various types of graphical user interfaces (GUIs), touch screens, microphones and other types of sensors that may receive some form of human-generated stimulus and generate a signal in response thereto.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 schematically illustrates a lighting control apparatus configured with selected aspects of the present disclosure, in accordance with various embodiments.

FIGS. 2-4 schematically depict examples of how apparatus configured with selected aspects of the present disclosure may be deployed, in accordance with various embodiments.

FIG. 5 schematically depicts an example of how a thermally conductive surface may be leveraged to control lighting using various techniques and apparatus described herein.

FIG. 6 depicts an example lighting control method, in accordance with various embodiments.

### DETAILED DESCRIPTION

Various technologies exist for controlling light using touch. These technologies include capacitive interfaces, resistive interfaces, acoustic interfaces, and optical imaging interfaces. However, these technologies are not necessarily ideal for controlling lighting because they are relatively expensive (or at least more expensive than is generally desired for lighting control applications) and/or technically cumbersome. Accordingly, there is a need for a more cost-effective, less cumbersome technology to control lighting using touch. More generally, Applicants have recognized and appreciated that it would be beneficial to employ technology already incorporated into many lighting products—namely, thermal imaging currently used for presence detection—to facilitate touch-based lighting control. In view of the foregoing, various embodiments and implementations of the present invention are directed to apparatus, systems, and methods for touch-based lighting control using thermal imaging.

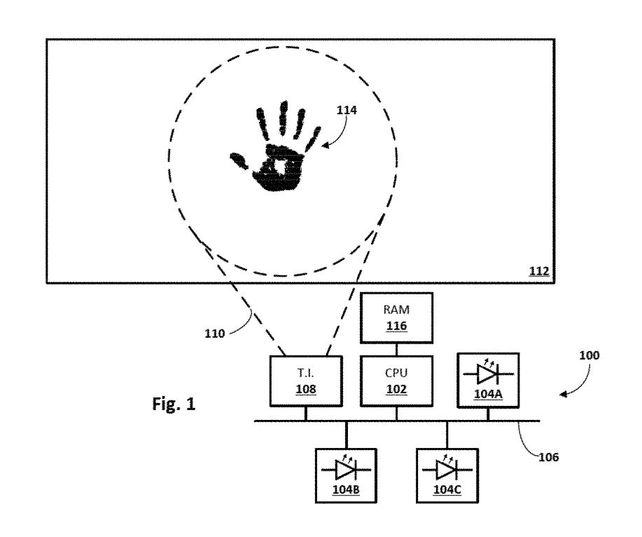

Referring to FIG. 1, in one embodiment, a lighting control apparatus 100 may include a controller (“CPU” in FIG. 1) 102 operably coupled with a plurality of light sources 104a-c, e.g., by one or more electrical and/or data links 106. In this example, plurality of light sources 104a-c includes three LED-based lighting units, but this is not meant to be limiting. In various embodiments, more or less light sources may be provided with lighting control apparatus 100, including no light sources. In addition, light sources 104 may take other forms, including but not limited to incandescent, halogen, fluorescent, and so forth. In some embodiments, controller 102 may also be operably coupled with memory 116 (“RAM” in FIG. 1) that includes instructions that are executable by controller 102 to perform techniques described herein.

Lighting control apparatus 100 may further include a thermal imaging sensor (“T.I.” in FIG. 1) 108, which may also be operably coupled with controller 102 via one or more links 106. In various embodiments, thermal imaging sensor 108 may be configured to employ infrared thermography or other similar techniques to sense heat and/or other forms of radiation within its field of view (“FoV”) 110, and to provide a signal indicative thereof, e.g., to controller 102. For example, thermal imaging sensor 108 may include a camera (not depicted) configured to detect radiation in the long-infrared range of the electromagnetic spectrum, such as between 9,000 and 14,000 nanometers, and produce a signal indicative of that radiation.

The “signal” provided by thermal imaging sensor 108 may come in various forms. In some embodiments, the signal may include data indicative of one or more digital images referred to as “thermograms.” In embodiments in which the signal includes data indicative of a digital image, various image processing techniques may be performed, e.g., by controller 102, to determine one or more characteristics of the heat captured within FoV 110. For example, various image processing techniques such as object recognition, edge detection, feature extraction, linear filtering, pattern recognition, thresholding, and so forth, may be used to determine a shape and/or location of captured heat within FoV 110. In some embodiments, a gradient of captured heat may provide spatiotemporal data that may be detected by controller 102. For example, immediately after a user swipes a surface, the first portion touched by the user will be slightly cooler than the last portion, and a gradient in temperatures may be observed, e.g., by controller 102, that is consistent with gradients known to represent a user swipe.

In various embodiments, controller 102 may be configured to analyze the signal provided by thermal imaging sensor 108 to detect heat present and/or captured in various mediums. In response to the signal and/or the analysis, controller 102 may cause one or more light sources 104a-c to emit light in a manner selected based on the signal provided by thermal imaging sensor 108. For example, in some embodiments, controller 102 may cause one or more light sources 104a-c to emit light having one or more properties (e.g., intensity, color temperature, hue, dynamic effect, beam spread, etc.) selected based on the signal provided by thermal imaging sensor 108.

Thermal imaging sensor 108 may have its FoV 110 pointed towards a particular surface 112, so that thermal imaging sensor 108 can sense heat captured at least temporarily by surface 112 within FoV 110. For example, in FIG. 1, a person has touched surface 112, leaving a thermal imprint 114 in the form of a handprint. In some embodiments, controller 102 may be configured to analyze the signal provided by thermal imaging sensor 108 to detect one or more characteristics of thermal imprint 114, such as its shape, duration, magnitude, location within FoV 110, etc. Based on the detected one or more characteristics, controller 102 may operate light sources 104a-c to emit light having one or more selected properties.

For example, in one simple embodiment, merely detecting presence of heat captured in surface 112 within FoV 110 may cause controller 102 to toggle one or more light sources 104 on or off In another embodiment, controller 102 may determine a length of time that heat is present in surface (based on the signal from thermal imaging sensor 108), and may operate one or more light sources 104 accordingly. For example, the intensity of light emitted by one or more light sources 104 may be increased or decreased (e.g., brightened, dimmed) in proportion to an amount of time that heat captured by surface 112 within FoV 110 is detected by thermal imaging sensor 108. In yet other embodiments, controller 102 may be configured to detect one or more aspects of a shape of thermal imprint 114, e.g., at a particular moment and/or across a time interval. In this manner, controller 102 may detect when a particular gesture such as a swipe, pinch, spread, nudge, double touch, etc., is performed on surface 112.

Lighting control apparatus 100 depicted in FIG. 1 includes light sources 104a-c. However, this is not meant to be limiting. In other embodiments, lighting control apparatus 100 may not include integral light sources 104. Instead, controller 102 and thermal imaging sensor 108 may be packaged together as a standalone kit. In some such embodiments, controller 102 may be communicatively and/or operatively coupled with one or more light sources using various technologies, such as ZigBee, Wi-Fi, simple electrical coupling (e.g., using wires), Ethernet, Bluetooth, etc., at the time of installation.

However, and referring to FIG. 2, in some embodiments, controller 202 and thermal imaging sensor 208 may be packaged together in a lighting unit 200. In some embodiments, lighting unit 200 may include one or more light sources 204 operably coupled with controller 202 within an envelope 222 that encloses the various components. In various embodiments, at least a portion of a surface 212 of envelope 222 may be thermally-conductive. Thermal imaging sensor 208 may have its FoV 210 pointed at an interior of surface 212. When a person touches surface 212 within FoV 210 of thermal imaging sensor 208, body heat may transfer from the person's appendage (shown as a pointed finger in FIG. 2) into surface 212. Depending on the level of thermal conductivity of surface 212, that heat may spread across surface 212 to various degrees. Further, depending on, among other things, the temperature of the environment and/or a heat transfer coefficient of surface 212, residual heat captured in surface 212 may dissipate over various time intervals.

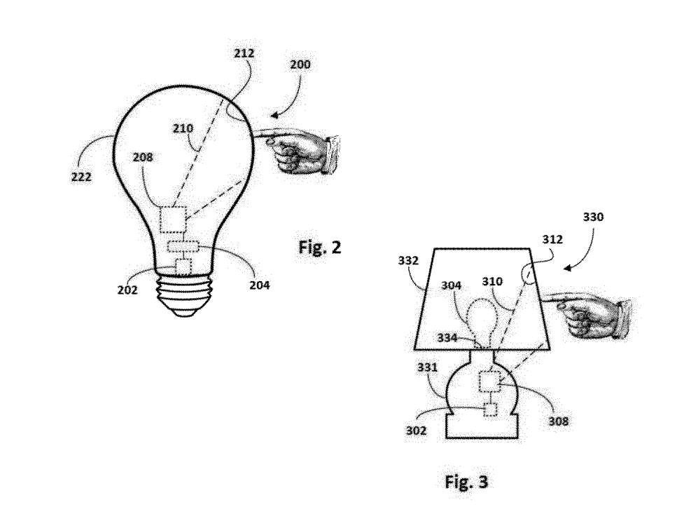

In other embodiments, the thermally conductive surface may be completely independent of the lighting control apparatus. FIG. 3 depicts an alternative configuration in which controller 302 and thermal imaging sensor 308 are packaged together on and/or within a body 331 of a table lamp 330. Thermal imaging sensor 308 has its FoV 310 pointed at an interior surface 312 of a lampshade 332. Lampshade 332 may or may not be constructed with materials selected to make it, or at least its interior surface 312 within FoV 310, thermally conductive. When a user touches the exterior of surface 312 of lampshade 332, heat is transferred from the person's appendage (a finger in FIG. 3) into surface 312. That transferred and/or captured heat may be sensed on the interior of surface 312 by thermal imaging sensor 308 as described above, and a signal indicative thereof may be provided to controller 302. Controller 302 may then operate a light source 304 installed into a socket 334 of lamp 330 (to which controller 302 may be communicatively coupled) in accordance with the received signal.

In some embodiments, one or more properties of light emitted by light source 304 may be selected based on a location within FoV 310 in which heat is sensed. For example, a user may touch a top half of lampshade 332 to increase intensity, and may touch a lower half to decrease intensity. The longer the user touches either half, the more the emitted intensity is altered (e.g., dimming). As another example, one or more spatiotemporal characteristics of a user's touch, such as a speed of a swipe across lampshade 332, may dictate one or more properties of light emitted by light source 304. In some embodiments, a user may even “write” characters on lampshade 332 using her finger. The residual heat left on lampshade 332 may be text recognized and used to determine one or more properties of light emitted by light source 304. For example, a user could “write” the letter “B” to emit blue light, the letter “R” to emit red light, the word “blink” to emit blinking light, a heart-shape to emit romantic light, etc.

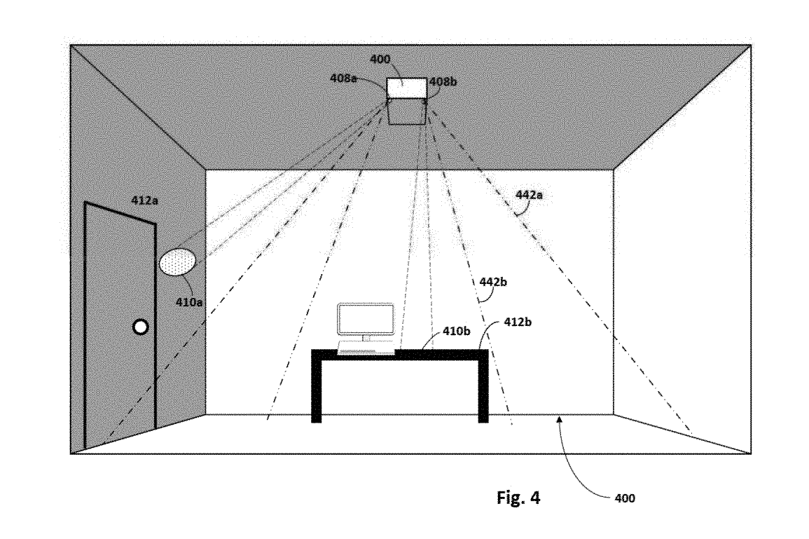

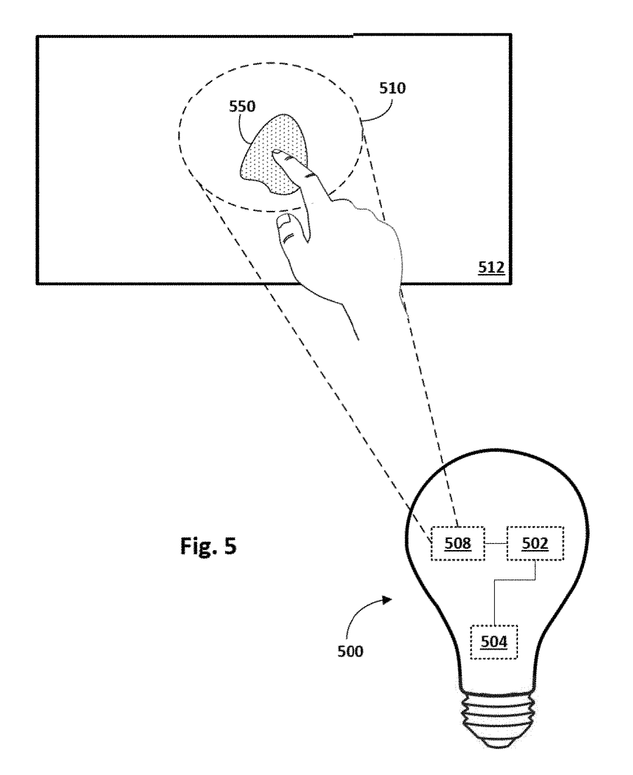

FIG. 4 depicts another example in which surfaces on which captured heat is detected and used to control lighting are independent of a lighting control apparatus. A luminaire 400 is installed on a ceiling of a room. Luminaire 400 includes two thermal imaging sensors, 408a and 408b, which may be coupled to a controller (not depicted in FIG. 4). First thermal imaging sensor 408a has its FoV 410a pointed at a first wall surface 412a. Second thermal imaging sensor 408b has its FoV 410b pointed at a desktop surface 412b next to a computer. While luminaire 400 includes two separate thermal imaging sensors, 408a and 408b, each with its own independent FoV, this is not meant to be limiting. In other embodiments, a single thermal sensor may have multiple fields of view.

In one embodiment, when a person enters the room through the door on the left, they may touch surface 412a of the left wall within FoV 410a in various ways to cause luminaire 400 to emit so-called “general lighting” to illuminate the entire room with a relatively wide and/or diffuse beam of light 442a (shown in dash-dot-dash). When the person sits down at the desk, e.g., to work at the computer, the person may touch surface 412b within FoV 410b in various ways, e.g., to cause luminaire 400 to emit so-called “task lighting” to illuminate a smaller area (e.g., around the desk) with a relatively narrow and/or more intense beam of light 442b (shown in dash-dot-dot-dash). In some embodiments, the user may be able to narrow or widen beams of light 442a and/or 442b, e.g., by touching surface 412a or 412b and performing various touch gestures, such as pinching (which may narrow one or both beams), or spreading (which may widen one or both beams).

In the examples above, the properties of emitted light that were selected based on captured heat sensed in surfaces included intensity and/or beam width. However, this is not meant to be limiting. Any property of light emitted by one or more light sources may be altered based on one or more sensed attributes of heat captured in a thermally conductive surface. For example, in some embodiments, a user may swipe along a thermally conductive surface to toggle through various hues or colors of a color gradient. In another embodiment, a controller may be configured to logically divide a surface captured in a FoV of a thermal imaging sensor into a color map. A user may touch different portions of the surface, and the controller may map the location of sensed captured heart to a corresponding color of the color map. In some embodiments, the controller may be configured to illuminate the thermally conductive surface within the FoV of the thermal imaging sensor with a pattern of light, e.g., showing the color map, to aid the user in selecting a color. Other properties of emitted light that may be altered based on captured heat sensed in surfaces include but are not limited to number of light sources energized, lighting scenes that are applied, dynamic effects (e.g., blinking, etc.), saturation, and so forth.

Also in the examples described above, the controller and thermal imaging sensors are described as being variously located in a lighting unit, a table lamp or luminaire, and so forth. However, this is not meant to be limiting. In various embodiments, the controller and thermal imaging sensors may be located elsewhere. For example, in some embodiments, a user's smart phone or tablet may include a controller and a thermal imaging sensor. A lighting control software application, or “app,” installed in memory (e.g., 116 in FIG. 1) on the smart phone or tablet may be configured to control one or more lighting units, e.g., using technologies such as Wi-Fi, Zigbee, Bluetooth, etc. The lighting control app may be further provided with access to the signal provided by the thermal imaging sensor. A user can point the thermal imaging sensor of the smart phone or tablet at a surface, and heat captured in that surface that is caused by human touch may be sensed. The thermal imaging sensor may provide a signal indicative of that detected heat to the lighting control app, which may then control the one or more lighting units based on one or more characteristics of the sensed heat.

As mentioned above, in various embodiments, a thermal imaging sensor may have its FoV pointed at a surface that is considered to be thermally conductive. A variety of materials may be selected as suitable surfaces based on their thermal conductivity. Table 1, below, lists a number of non-limiting examples.

TABLE 1

| | Thermal Conductivity | |
|---|---|---|
| Material | (Watts per meter Kelvin) | |
| Foamed plastic | 0.02 | W/mK |
| Conventional plastic | 0.2 | W/mK |
| Glass | 2.0 | W/mK |
| Thermally conductive plastic | 1-20 | W/mK |
| Steel | 50 | W/mK |
| Aluminum | 200 | W/mK |
| Copper | 400 | W/mK |
| Diamond | 1,500 | W/mK |

Depending on the desired lighting control functionality, various materials, such as one or more of those listed in Table 1, may be selected for use in a surface at which a FoV of a thermal imaging sensor is pointed. In some embodiments, various mechanisms may be deployed to create a suitably thermally conductive surface. For example, a removable surface such as a sticker or magnet constructed with one or more thermally conductive materials may be placed at a desired location that may otherwise be insufficiently thermally conductive. A thermal imaging sensor may be pointed at the removable surface, and light may be controlled based on how users touch the removable surface.

Suppose a thermal imaging sensor (e.g., 108, 308, 408a or b) has its FoV pointed at a remote surface such as a wall, floor, ceiling, etc. When a user touches the surface from a position between the thermal imaging sensor and the surface, the user's body will likely obstruct at least a portion of the surface from the thermal imaging sensor, including the portion of the surface that the user is actually touching. To address this, a material having suitable thermal conductivity may be selected as the surface. That way, the user's body heat not only transfers into the portion of the surface that the user is actually touches, but the body heat propagates along the surface in one or more additional directions as well. This propagated heat may be less likely to be obstructed by the user, and more likely to be visible to the thermal imaging sensor.

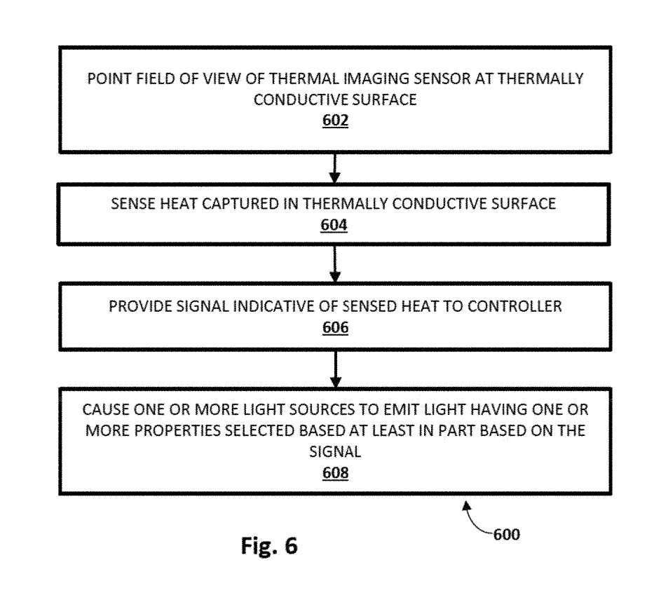

An example of this is depicted in FIG. 5. A lighting unit 500 is equipped with various aspects of the present disclosure, including a controller 502 operably coupled with a thermal imaging sensor 508 and one or more light sources 504. Thermal imaging sensor 508 has its FoV 510 pointed at a remote surface 512 (e.g., a wall, a ceiling, a floor, a desktop, etc.). However, as is depicted, a user's hand that touches surface 512 within FoV 510 obstructs the portion of surface 512 that the user is actually touching. To ensure thermal imaging sensor 508 still detects heat captured in surface 512, at least a portion of surface 512 within FoV 510 may be thermally conductive. This facilitates propagation of heat 550 throughout surface 512 so that heat 550 is visible to thermal imaging sensor 508 around the user's finger/hand. Thermal imaging sensor 508 may provide a signal indicative of the propagated heat 550 to controller 502, similar to the embodiments described above. Controller 502 may operate one or more light sources 504 to emit light having one or more properties selected based on the signal from thermal imaging sensor 508. FIG. 6 depicts an example lighting control method 600, in accordance with various embodiments. While the operations of method 600 are depicted in a particular order, this is not meant to be limiting. In various embodiments, one or more operations may be added, omitted, and/or reordered.

At block 602, A FoV (e.g., 110, 210, 310, 410, 510) of a thermal imaging sensor (e.g., 108, 208, 308, 408, 508) may be pointed at a thermally conductive surface. As noted above, in some embodiments, the thermally conductive surface may be integral with (or at least packaged with) a lighting control apparatus (e.g., 100) configured with selected aspects of the present disclosure, e.g., as part of a lighting unit (see FIG. 2) or as part of a lamp (see FIG. 3). In other embodiments, the thermally conductive surface may be independent and/or remote from the lighting control apparatus, as was the case in FIGS. 4 and 5.

At block 604, the thermal imaging sensor may sense heat captured in the thermally conductive surface. At block 606, the thermal imaging sensor may generate and provide a signal indicative of the sensed heat to a controller. In some embodiments, the thermal imaging sensor may be configured to raise a signal indicative of heat only within a predetermined temperature range (e.g., as would be caused by human touch), and to ignore other temperatures (e.g., that might be caused by errant sunlight, a pet, etc.). In other embodiments, the thermal imaging sensor may provide a signal indicative of any temperature detected in the thermally conductive surface, e.g., a continuous signal, and it may be up to a controller that receives the signal to determine which sensed heat was likely caused by human touch, and which sensed heat was likely caused by an event that is not meant to cause a change in lighting (e.g., a pet brushing against the surface).

At block 608, the controller may cause one or more light sources to emit light having one or more properties selected based on the signal the controller received from the thermal imaging sensor at block 606. As noted above, if the controller is integral with one or more light sources in a lighting unit (e.g., FIG. 2 or FIG. 5), the controller may transmit commands/voltage/current to the light sources over one or more buses. If the light sources are LED-based light sources, then the controller may transmit the commands to an LED driver associated with the LEDs. If the controller (and lighting control apparatus as a whole) is separate from the one or more light sources, then the controller may transmit one or more lighting control commands to the light sources using various wired or wireless communication technologies, such as Wi-Fi, Bluetooth, Ethernet, ZigBee, and so forth.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03. It should be understood that certain expressions and reference signs used in the claims pursuant to Rule 6.2(b) of the Patent Cooperation Treaty (“PCT”) do not limit the scope.

1. An apparatus, comprising:
a controller; and
a thermal imaging sensor operably coupled with the controller and having at least one field of view pointed at a surface;
wherein the controller is configured to:
receive a signal from the thermal imaging sensor, the signal being indicative of a thermal imprint created on the surface by a user and sensed by the thermal imaging sensor;
identify, based on processing of the signal, one or more spatial or temporal aspects of the termal imprint; and
transmit one or more commands selected based on the one or more identified spatial or temporal aspects.

2. The apparatus of claim 1, wherein the one or more spatial or temporal aspects comprise a heat gradient of the thermal imprint.

3. The appartus of claim 2, wherein the one or more spatial or temporal aspects further comprise a temporal direction associated with the heat gradient.

4. The appartus of claim 1, wherein the one or more spatial or temporal aspects comprise a shape of the thermal imprint.

5. The apparatus of claim 1, wherein the one or more spatial or temporal aspects comprise a location of the thermal imprint within the field of view.

6. The apparatus of claim 5, further comprising a light source, wherein the controller is further configured to operate the light source to illuminate the surface within the at least one field of view with a pattern of light to deliniate between a plurality of regions of the surface within the field of view.

7. The appartus of claim 6, wherein the one or more spatial or temporal aspects comprise a region of the plurality of regions in which the thermal imprint is sensed.

8. The apparatus of claim 1, wherein the surface is independent from the apparatus.

9. The apparatus of claim 1, wherein the surface comprises a wall, ceiling, or floor of a room in which the apparatus is installed.

10. A method comprising:
pointing a thermal imaging sensor at a thermally conductive surface;
sensing, at the thermal imaging sensor, a thermal imprint captured in the thermally conductive surface;
providing a signal indicative of one or more spatial or temporal aspects of the termal imprint to a controller; and
transmitting, by the controller, one or more commands selected based on the one or more identified spatial or temporal aspects.

11. The method of claim 10, wherein the sensing comprises sensing a shape of the thermal imprint within a field of view of the thermal imaging sensor.

12. The method of claim 10, wherein the sensing comprises sensing a location of the thermal imprint within a field of view of the thermal imaging sensor.

13. The method of claim 10, wherein the one or more spatial or temporal aspects comprise a heat gradient of the thermal imprint.

14. The method of claim 13, wherein the one or more spatial or temporal aspects further comprise a temporal direction associated with the heat gradient.

15. The method of claim 10, further comprising illuminating the thermally-conductive surface with a pattern of light to visually deliniate between a plurality of regions of the thermally conductive surface, wherein the one or more spatial or temporal aspects comprise a region of the plurality of regions in which the thermal imprint is sensed.
